(19) United States
(12) Patent Application Publication
(10) Pub. No.: US 2009/0086002 A1
(43) Pub. Date: Apr. 2, 2009

(54) METHOD FOR PRINTING A SUBSTRATE WEB

(75) Inventors: Peter Schulmeister, Pfaffenhofen (DE); Robert Weiss, Gersthofen (DE); Florian Fejfar, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Manroland AG, Offenbach/Main (DE)

(21) Appl. No.: 12/239,405

(22) Filed: Sep. 26, 2008

(30) Foreign Application Priority Data
Sep. 29, 2007 (DE) 10 2007 046 771.2

(51) Int. Cl. B41J 2/01

(52) U.S. Cl. 347/105

(57) ABSTRACT

A method for printing a substrate web in a rotary printing press is disclosed. The substrate web to be printed is conveyed through a printing form-based printing unit for static printing of the substrate web with a print image that does not vary for the print copies of a printing job, such that at least one static print page is printed in the longitudinal direction of the substrate web per revolution of the form cylinder and several static print pages are printed on the substrate web across the longitudinal direction of the substrate web. In addition to static printing, the statically printed substrate web is printed dynamically with a variable print image in the area of a printing form-free printing device of the rotary printing press such that the print format of the printing form-free printing device extends in at least some sections over at least two statically printed pages.

This application claims the priority of German Patent Document No. 10 2007 046 771.2, filed Sep. 29, 2007, the disclosure of which is expressly incorporated by reference herein.

### BACKGROUND AND SUMMARY OF THE INVENTION

The invention relates to a method for printing a substrate web in a rotary printing press.

Rotary printing presses have several printing form-based printing units for static printing of at least one substrate web with a print image comprising several pages of print that are the same for all print copies of a printing job. Such printing form-based printing units, which are used for static printing of the/each substrate web, are typically designed as offset printing units. It is likewise possible for printing form-based printing units to be embodied as gravure printing units. In practice, it is already known that in addition to the printing form-based printing units, which are used for static printing of the/each substrate web with a print image that is the same for all print copies, at least one printing form-free printing device may be provided in a rotary printing press to additionally individualize print copies, in particular in-line, for static printing, such that at least one substrate web is printed dynamically using a print image that is variable for at least some print copies. Such a printing form-free printing device may be, for example, an inkjet printing device or an electrophotographic printing device, such as a laser printing device or an ionographic printing device. With the methods known in practice for printing a substrate web, a print format of the/each printing form-free printing device is coupled to a print format of the/each printing form-based printing unit, so that dynamic printing of a substrate web may always take place only within one print page of the static imprint of the respective substrate web. This limits the design options for print products.

Against this background, the object of the present invention is to create a novel method for printing a substrate web in a rotary printing press.

According to a first aspect of the invention, at least one substrate web to be printed is conveyed through at least one printing form-based printing unit of the rotary printing press for static printing of the same with a print image that is non-varying for the print copies of a printing job, whereupon at least one printing form is positioned on form cylinders of the/each printing form-based printing unit, as seen in the circumferential direction of the form cylinders, and at least one printing form is positioned in the axial direction of the form cylinder, with the help of which at least one static print page is printed per revolution of the form cylinder in the longitudinal direction of the substrate web and several static print pages are printed with a defined print format on the respective substrate web across the longitudinal direction of the substrate web, such that, in addition to static printing, at least one of the statically printed substrate webs is also printed dynamically with a print image that is variable for at least some print copies, in the area of at least one printing form-free printing device of the rotary printing press, in particular in-line, such that the print format of the respective printing form-free printing device, as seen in the longitudinal direction of the substrate web, extends in at least some sections over at least two print pages that are printed with the same printing form and are positioned one after the other in the longitudinal direction of the substrate web and/or extends in at least some sections over at least two print pages that are printed with the same printing form or with different printing forms and are positioned side-by-side across the longitudinal direction of the substrate web.

According to a second aspect of the invention, at least one substrate web to be printed is conveyed through at least one printing form-based printing unit of the rotary printing press for static printing of the substrate web with a print image that is non-varying for the print copies of one printing job, such that several printing forms are positioned on form cylinders of the/each printing form-based printing unit in the circumferential direction of the form cylinder and several printing forms are positioned in the axial direction of the form cylinder, with the help of which at least two static print pages are printed per revolution of the form cylinder in the longitudinal direction of the substrate web and at least two static print pages are printed with a defined print format on the respective substrate web across the longitudinal direction of the substrate web, such that, in addition to the static printing, at least one of the statically printed substrate webs is also printed dynamically with a variable print image for at least some print copies in the area of at least one printing form-free printing device of the rotary printing press, in particular in-line, such that the print format of the respective printing form-free printing unit extends at least in some sections over at least two print pages that are positioned one after the other and are printed with different printing forms and/or extends in at least some sections over at least two printing pages that are printed with different printing forms or with the same printing form and are positioned side-by-side across the longitudinal direction of the substrate web.

In the inventive method for printing a substrate web, the print format of the/each printing form-free printing device is completely separate from the print format of the/each printing form-based printing unit, so that dynamic printing of a substrate web may extend at least in some sections over at least two print pages of the static impression of the respective substrate web. This yields completely novel design possibilities for print products.

Preferred further embodiments of the invention are derived from the following description. Exemplary embodiments of the invention are explained in greater detail on the basis of the drawings without being limited thereto.

### BRIEF DESCRIPTION OF THE DRAWINGS

FIG. 1 shows a schematic diagram of a static print image printed on a substrate web with one revolution of a form cylinder of a printing form-based printing unit;

FIG. 2 shows a detail of the diagram of FIG. 1 together with a dynamic print image printed with the help of a printing form-free printing device on the substrate web;

FIG. 3 shows another detail of the diagram from FIG. 1 together with a dynamic print image printed on the substrate web with the help of a printing form-free printing device; and

FIG. 4 shows a detail of a static print image printed on a substrate web with several revolutions of a form cylinder of a printing form-based printing unit together with a dynamic print image printed on the substrate web with the help of a printing form-free printing device.

### DETAILED DESCRIPTION OF THE DRAWINGS

The invention relates to a method for printing at least one substrate web in a rotary printing press. To do so, at least one substrate web that is to be printed is conveyed through at least one printing form-based printing unit of the rotary printing press for static printing of the same with a print image that is non-varying for the print copies of a printing job.

The/each printing form-based printing unit is preferably an offset printing unit having multiple offset printing devices, such that each offset printing mechanism of an offset printing unit comprises a form cylinder, a transfer cylinder, an inking unit and preferably a dampening unit.

On a form cylinder of an offset printing mechanism of an offset printing unit of a rotary printing press, at least one printing form is positioned in the circumferential direction of the form cylinder and at least one printing form is positioned in the axial direction of the form cylinder. Then when the form cylinder is being used with printing forms designed as printing sleeves, a single printing form is usually positioned on a form cylinder, the printing form extending in both the axial direction and the circumferential direction of the respective form cylinder in a closed configuration around the form cylinder. Then, however, when printing forms designed as printing plates are used, typically several printing forms are positioned one after the other on a form cylinder, namely one or two printing forms in the circumferential direction of the form cylinder, and two, four or six printing forms side-by-side in the axial direction of a form cylinder.

With the help of the offset printing mechanisms of an offset printing unit of a rotary printing press, at least one static print page is printed with a defined print format on the respective substrate web to be printed per revolution of the form cylinder, as seen in the longitudinal direction of the substrate web, and several static print pages are printed per revolution, as seen across the longitudinal direction of the substrate web.

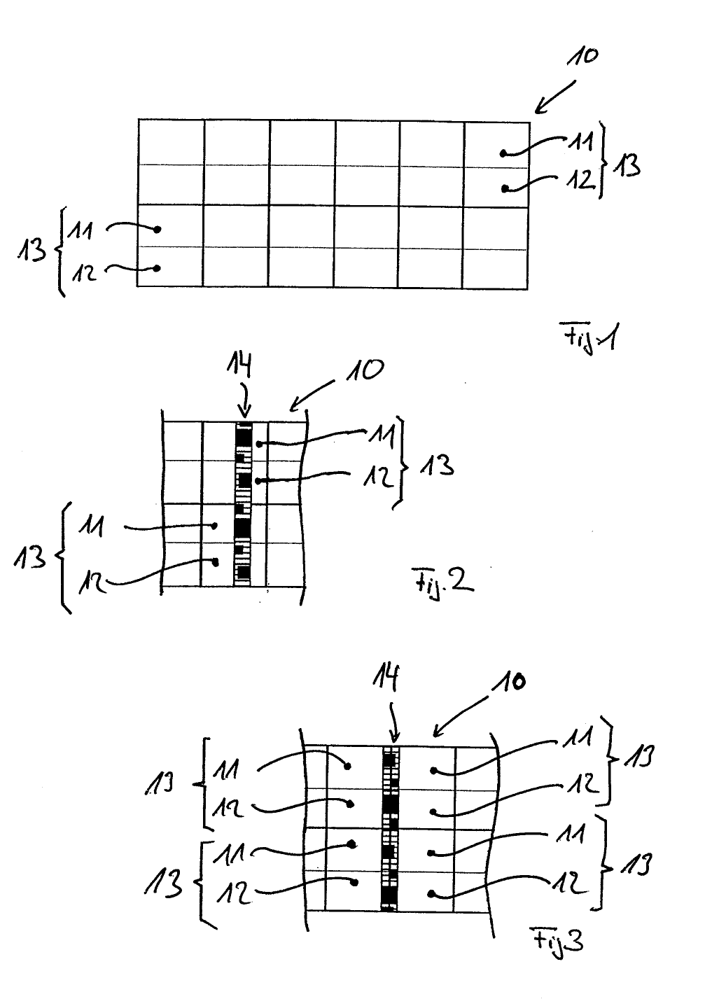

Thus, FIG. 1 shows in a highly schematized form a diagram of a static print image 10 printed on a substrate web with one revolution of a form cylinder of a printing form-based printing unit, whereby six printing forms are arranged side-by-side on the form cylinder as seen in the axial direction and two printing forms are positioned one after the other as seen in the circumferential direction. With each of the 12 printing forms, in the exemplary embodiment shown here, two print pages 11, 12 can be printed statically one after the other in the longitudinal direction of the substrate web so that according to FIG. 1, twenty-four print pages are printed on the respective substrate web per revolution of the form cylinder. In FIG. 1 the static print image comprising two print pages 11, 12 printable with one printing form is visualized with reference numeral 13.

It should be pointed out here that the invention is not limited to the application case of 6/2 form cylinders shown in FIG. 1, in which six printing forms are positioned side-by-side on the form cylinders in the axial direction thereof and two printing forms are positioned one after the other in the circumferential direction thereof.

Instead, the invention may also be used with so-called 4/2 form cylinders or 4/1 form cylinders or 2/2 form cylinders or 2/1 form cylinders, whereby the first number denotes the number of printing forms positioned side-by-side on the form cylinder in the axial direction and the second number denotes the number of printing forms positioned one after the other on the form cylinder in the circumferential direction.

Likewise, the inventive method may be used when exclusively a single printing form, e.g., designed as a printing sleeve, is arranged on the form cylinders, such that at least one static print page is printed on the respective substrate web with a defined print format per revolution of the corresponding form cylinder, as seen in the longitudinal direction of the substrate web, when using such a sleeve-shaped printing form and several static print pages are printed on the respective substrate web as seen across the longitudinal direction of the substrate web.

In the sense of the present invention, at least one substrate web is printed statically with multiple print pages in the manner described above in a rotary printing press in the area of at least one printing form-free printing device of the rotary printing press designed as an inkjet printing device and, in addition to the static printing, is also printed dynamically with a print image that is variable for at least some print copies, in particular in-line.

Then, when at least one printing form is positioned on the form cylinder as seen in the circumferential direction thereof and at least one printing form is positioned on the form cylinder in the axial direction thereof such that with the help of these printing forms at least one static print page is printed on the respective substrate web in the longitudinal direction of the substrate web per revolution of the form cylinder, and several static printing pages are printed on the respective substrate web with the defined print format across the longitudinal direction of the substrate web, the dynamic printing takes place in such a way that the print format of the respective printing form-free printing device extends at least by sections over at least two print pages printed with the same printing form and positioned one after the other in the longitudinal direction of the substrate web and/or extends in at least some sections over at least two print pages printed with the same printing form or with different printing forms and positioned side-by-side across the longitudinal direction of the substrate web.

The print format of the printing form-free printing device may extend in at least some sections over a single revolution of the form cylinder of the printing form-based printing units or may extend in at least some sections over multiple revolutions of the form cylinder of the/each printing form-based printing unit in the longitudinal direction of the substrate web.

Then, when, as shown in the exemplary embodiment in FIG. 1, multiple printing forms are positioned on the form cylinders of the/each printing form-based printing unit, as seen in the circumferential direction of the form cylinder, and several printing forms are positioned as seen in the axial direction of the form cylinder such that with their help at least two static print pages are printed on the respective substrate web per revolution of the form cylinder, as seen in the longitudinal direction of the substrate web, and likewise at least two static print pages are printed on the substrate web with a defined print format on the respective substrate web, as seen across the longitudinal direction of the substrate web, then the dynamic printing of the respective substrate web takes place in such a way that the print format of the respective printing form-free printing device extends in at least some sections over at least two print pages that are positioned one after the other in the longitudinal direction of the substrate web and are printed with different printing forms and/or in at least some sections over at least two print pages printed with different printing forms and/or with the same printing form and positioned side-by-side across the longitudinal direction of the substrate web.

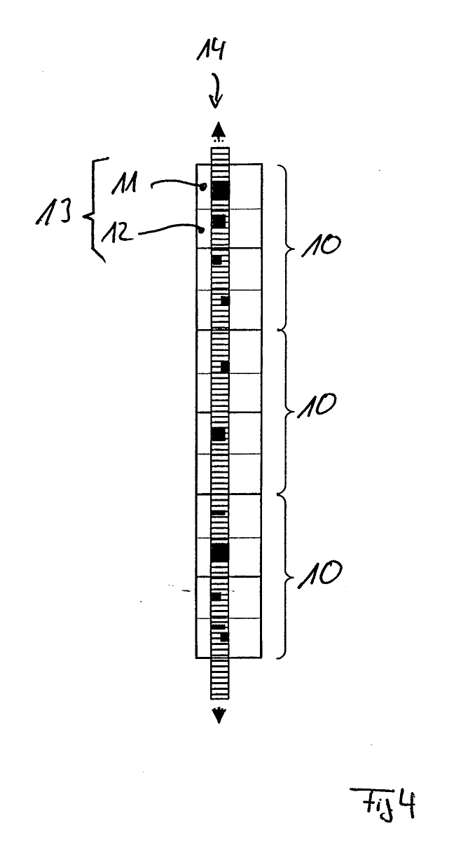

FIG. 2 thus shows a detail of the static print image 10 of FIG. 1, whereby the print format of a dynamic printing 14 extends completely over the static printing of two printing forms positioned on the form cylinder one after the other in the circumferential direction, namely according to FIG. 2 over a total of four print pages 11, 12, 11, 12, which are printed with the help of two printing forms on the respective substrate web, as seen in the longitudinal direction of the substrate web. FIG. 3 illustrates a variant of the invention presented here, in which the dynamic printing 14 thus also extends in some sections over two print pages that are printed with different printing forms and are positioned side-by-side across the longitudinal direction of the substrate web. In the exemplary embodiment of FIG. 3, the dynamic printing 14 thus extends by sections over a total of eight printing pages.

In FIGS. 2 and 3, the format of dynamic printing extends over a single revolution of the form cylinder of the respective printing form-based printing unit as seen in the longitudinal direction of the substrate web. In contrast with that, FIG. 4 shows a diagram in which the format of the dynamic impression 14 extends in at least some sections over several revolutions of the form cylinder of the/each printing form-based printing unit as seen in the longitudinal direction of the substrate web, such that FIG. 4 shows details of a total of three static print images 10, which are printed on the respective substrate web with three revolutions. The format of the dynamic impression 14 may extend over any number of revolutions of the form cylinder.

With the present invention, it is thus possible to design the format of a dynamic impression with the help of at least one printing form-free printing unit such that, regardless of the print format of the static impression, the print format of the dynamic impression may extend over at least two print pages as seen in the longitudinal direction of the substrate web and/or across the longitudinal direction of the substrate web, namely extending over print pages that are printed either with the same printing form or preferably with different printing forms on the substrate web. Dynamic printing which extends beyond the print page and/or beyond the printing form allows completely novel design options for print products.

Within the print format for the dynamic impression, impressions and thus actually printed regions of the print pages may be defined freely, such that actually printed areas within the print format are depicted as solid black rectangles for the dynamic impression in FIGS. 2 to 4. Areas shown with stripes outside of the black rectangles also belong to the print format for the dynamic impression but they are not filled in with ink or color and thus are not in fact dynamically printed.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for printing a substrate web in a rotary printing press, wherein the substrate web that is to be printed is conveyed through a printing form-based printing unit of the rotary printing press for static printing of the substrate web with a non-varying print image for print copies of a printing job, wherein at least one printing form is positioned on a form cylinder of the printing form-based printing unit as seen in a circumferential direction of the form cylinder and at least one printing form is positioned on the form cylinder as seen in an axial direction of the form cylinder such that with the printing forms, at least one static print page is printed with a defined print format on the substrate web in a longitudinal direction of the substrate web per revolution of the form cylinder and multiple static print pages are printed with a defined print format on the substrate web across the longitudinal direction of the substrate web, such that the statically printed substrate web is printed dynamically with a variable print image in-line by a printing form-free printing device of the rotary printing press, such that a print format of the printing form-free printing device extends in the longitudinal direction in at least some sections of at least two print pages printed with a same printing form and positioned one after the other in the longitudinal direction of the substrate web and/or extends in at least some sections over at least two print pages printed with the same printing form or with different printing forms and positioned side-by-side across the longitudinal direction of the substrate web.

2. The method according to claim 1, wherein the print format of the printing form-free printing device extends in at least some sections over a single revolution of the form cylinder of the printing form-based printing unit as seen in the longitudinal direction of the substrate web.

3. The method according to claim 1, wherein the print format of the printing form-free printing device extends in at least some sections over several revolutions of the form cylinder of the printing form-based printing unit as seen in the longitudinal direction of the substrate web.

4. A method for printing a substrate web in a rotary printing press, wherein the substrate web to be printed is conveyed through a printing form-based printing unit of the rotary printing press for static printing of the substrate web with a non-varying print image for print copies of a printing job, such that several printing forms are positioned on a form cylinder of the printing form-based printing unit as seen in a circumferential direction of the form cylinder and several printing forms are positioned on the form cylinder as seen in an axial direction of the form cylinder, such that the printing forms print at least two static print pages with a defined print format on the substrate web per revolution of the form cylinder in a longitudinal direction of the substrate web, such that the statically printed substrate web is printed dynamically with a variable print image by a printing form-free printing device of the rotary printing press in-line such that a print format of the printing form-free printing device extends in at least some sections over at least two pages printed with different printing forms and positioned one after the other as seen in the longitudinal direction of the substrate web and/or extends in at least some sections over at least two print pages printed with the same printing form or with different printing forms and positioned side-by-side across the longitudinal direction of the substrate web.

5. The method according to claim 4, wherein the print format of the printing form-free printing device extends in at least some sections over a single revolution of the form cylinder of the printing form-based printing unit as seen in the longitudinal direction of the substrate web.

6. The method according to claim 4, wherein the print format of the printing form-free printing device extends in at least some sections over several revolutions of the form cylinder of the printing form-based printing unit as seen in the longitudinal direction of the substrate web.

7. A method for printing a substrate web in a rotary printing press, comprising the steps of:
statically printing at least two copies on the substrate web by a printing form-based printing unit with a static print image that does not vary on the at least two copies; and
dynamically printing the statically printed at least two copies with a variable print image by a printing form-free printing device in at least some sections on the statically printed at least two copies.

8. The method according to claim 7, wherein the at least two copies extend in a longitudinal direction of the substrate web.

9. The method according to claim 7, wherein the at least two copies extend across a longitudinal direction of the substrate web.

10. The method according to claim 7, wherein the printing form-based printing unit includes a form cylinder.

11. The method according to claim 7, wherein the printing form-free printing device is an inkjet printing device.
